(19) United States
(12) Patent Application Publication
(10) Pub. No.: US 2008/0215604 A1
(43) Pub. Date: Sep. 4, 2008

(54) Processing Pedigree Data

(76) Inventors: Bryce Little, New South Wales (AU); John Henshall, New South Wales (AU)

Correspondence Address: COOPER & DUNHAM, LLP, 1185 AVENUE OF THE AMERICAS, NEW YORK, NY, 10036, US

(21) Appl. No.: 11/886,054

(22) PCT Filed: Mar. 10, 2006
(86) PCT No.: PCT/AU2006/000324

§ 371 Date: Jan. 16, 2008

(30) Foreign Application Priority Data
Mar. 11, 2005 (AU) 2005901166

(51) Int. Cl. G06F 9/30; G06F 17/30

(52) U.S. Cl. 707/101; 712/30; 707/E17.009; 712/E09.016

(57) ABSTRACT

A device, namely, one of a Field Programmable Gate Array (FPGA) device and an Application Specific Integrated Circuit (ASIC) is described. The FPGA or ASIC is configured to represent one or more pedigree data structures, each structure comprising at least two generations. The device comprises a plurality of logic cells arranged such that one or more of the logic cells model a module of the pedigree data structure, where each module of the pedigree data structure is representative of an individual in a pedigree, input circuitry to receive pedigree data and output circuitry to output processed data; and electrical connections between the logic cells and the input and output circuitry. The arrangement of the logic cells and electrical connections enable parallel processing on a loaded pedigree data structure such that the transmission of pedigree data through at least a subset of the, or each, pedigree data structure occurs in each sampling cycle. A method and data structure are further disclosed.

### TECHNICAL FIELD

The invention concerns a device, namely one of a Field Programmable Gate Array (FPGA) device and an Application Specific Integrated Circuit (ASIC), configured to represent one or more pedigree data structures. The invention further concerns a method for processing pedigree data, for instance to estimate allelic or haplotype probabilities in humans and agricultural species.

### BACKGROUND ART

Traits or characteristics of an organism are determined by genes. The gene for a particular trait can have two or more different forms, referred to as alleles. Alleles exist at a specific location on a chromosome and are separated from each other during meiosis. For every gene, an individual has two alleles, one inherited from each parent. Haplotypes are a combination of alleles at different markers along the same chromosome that are inherited as a unit. It is highly desirable to deduce, from a pedigree, the allelic or haplotype probability.

Where the parentage of individuals is known, information from multiple individuals can be combined to form a pedigree data structure. Such structures are highly regular since each individual has two parents regardless of whether the identity of either parent is known. Pedigree data structures have a number of applications in genetics, including the estimation of allelic or haplotype probability in humans and agricultural species, to determine the likelihood for disease transmission, and the estimation of breeding values in agricultural species.

Efficient sequential algorithms exist for many analysis tasks on pedigree data. Sequential algorithms for general purpose CPU based computers are commonly used, but are inadequate for some tasks on large data sets. For large complex pedigrees with marriage or interbreeding loops sampling based algorithms may be used. Given the large data sets inherent in many pedigrees it is highly desirable that such deduction occur in an efficient manner and improvements in speed are continuously being sought.

### DISCLOSURE OF INVENTION

In a first aspect, the invention is a device, namely, one of a Field Programmable Gate Array (FPGA) device and an Application Specific Integrated Circuit (ASIC), configured to represent one or more pedigree data structures, each structure comprising at least two generations, the device comprising:

a plurality of logic cells arranged such that one or more of the logic cells model a module of the pedigree data structure, where each module of the pedigree data structure is representative of an individual in a pedigree;

input circuitry to receive pedigree data and output circuitry to output processed data; and

electrical connections between the logic cells and the input and output circuitry;

where the arrangement of the logic cells and electrical connections enable parallel processing on a loaded pedigree data structure such that the transmission of pedigree data through at least a subset of the, or each, pedigree data structure occurs in each sampling cycle.

A subset of the pedigree data structure may be defined as any number of individuals making up the pedigree.

In one embodiment, the subset of the pedigree data structure may comprise a generation of the pedigree. In other embodiments, the subset of the pedigree data structure may comprise a part of a generation of the pedigree, or part of several generations of the pedigree. Optionally, the subset of the pedigree data structure may comprise all generations of the pedigree. Optionally, duplicate copies of a pedigree data structure may be represented on the device and the subset of each pedigree data structure may comprise an individual of each pedigree, or two or more individuals of each pedigree.

Each sampling cycle may comprise any number of clock cycles. In one embodiment each sampling cycle may comprise two clock cycles. In a further embodiment each sampling cycle may comprise a single clock cycle.

At least a pair of modules may be provided which are representative of at least a pair of holder modules such that pedigree data is passed through the subset of the pedigree data structure while remaining in synchronicity with the rest of the data dropping through the pedigree data structure.

The modules may comprise founder modules for representing individuals whose parents are unknown and descendant modules for representing individuals whose parents are known.

The device may further comprise a plurality of data counters, where each data counter is representative of an individual in the pedigree and where the data counters comprise one of allele counters to count the frequency of occurrence of a particular allele and haplotype counters to count the frequency of occurrence of a particular haplotype.

Each data counter may include a data authenticator operable to check received data against known data and to output a signal indicative of whether the received data for the individual is representative of the individual.

The device may further comprise a filter associated with the data authenticator, the filter operable to reject the entire sample if the propagated data for any one of the individuals is inconsistent with the known data.

The device may further comprise a generator for generating the pedigree data.

The device according may further comprise an inheritance generator for generating inheritance data, where the generation of data is based on one of the following processes, random, systematic enumeration of available values, and a strategic combination of pedigree type and genotype data and/or previous samples.

The generated data may be weighted according to user-defined proportions. A new sample of pedigree data may be generated for each clock cycle of the FPGA or ASIC. A single sample of pedigree data may include a set of alleles for each of the founder modules and a set of inheritance switches for each of the descendent modules.

Associated with each individual may be records of genotype. Records of genotype may include molecular markers from some segment on a chromosome, or implied genotype through observed presence or absence of a genetically determined characteristic. Quantitative trait measurements may also exist for some or all individuals.

The device, when in the form of an FPGA, may further include a processor in communication with the input circuitry, electrical connections and a host computer to enable reconfiguration of the FPGA for different pedigrees.

In a second aspect the invention is a method for processing pedigree data, the method comprising:

representing one or more pedigree data structures in one of a Field Programmable Gate Array (FPGA) device and an Application Specific Integrated Circuit (ASIC), each structure comprising at least two generations; and

operating on the, or each, pedigree data structure in parallel such that transmission of pedigree data through a subset of the pedigree data structure occurs in each sampling cycle.

The method may further comprise translating pedigree data into a structure for mapping into the electronic fabric of the FPGA device or the electronic fabric of the ASIC.

Mapping into the electronic fabric FPGA may include configuring clusters of logic cells of the FPGA to represent individual components of the data structure and programming connections between the clusters.

The method may further comprise generating the pedigree data. Generating the pedigree data may occur according to a process selected from random generation, systematic enumeration of available values, and a strategic combination of pedigree type and genotype data and/or previous samples. The method may further comprise weighting the generated data according to user-defined proportions.

The method may further comprise generating a new sample of pedigree data for each sampling cycle.

Operating on the pedigree data structure may comprise propagating each sample of pedigree data from one generation to the next.

Optionally, duplicate copies of a pedigree data structure may be represented. In this instance Operating on each of the pedigree data structures may comprise propagating pedigree data through an individual of each pedigree.

The method may further comprise authenticating propagated data against known data and outputting a signal indicative of whether the propagated data for an individual of the pedigree is representative of the individual.

The method may further comprise rejecting the entire sample if the propagated data for any one of the individuals is inconsistent with the known data.

The method may further comprising translating the propagated data into a form suitable for analysis on a PC or the like, to determine, at least one of, the estimation of allelic probabilities, the estimation of haplotype probabilities and the calculation of inbreeding coefficients.

The method may comprise converting data into binary representation.

The method may further comprise storing the results from each of the accepted samples for each individual to determine, for instance, the estimation of allelic probabilities, the estimation of haplotype probabilities and the calculation of inbreeding coefficients.

In a third aspect the invention is a pedigree data structure held on one of a Field Programmable Gate Array (FPGA) device and an Application Specific Integrated Circuit (ASIC), the structure comprising:

a plurality of modules each representative of an individual in the pedigree;

where one or more electrically connected logic cells of the FPGA, or ASIC, model each module of the pedigree data structure, and where the modules are configured to enable operation on the pedigree data structure in parallel such that the transmission of pedigree data through at least a subset of the individuals occurs in each sampling cycle.

The entire pedigree data structure may be represented on the FPGA device or the ASIC.

The FPGA device or the ASIC may include a copy of the entire pedigree data structure.

Pedigree data may include, but not be limited to, one or more of: allele data, haplotype data, data relating to microsatellite markers, and data relating to single nucleotide polymorphisms.

The pedigree data structure may further comprise a plurality of data counters, where each data counter is representative of an individual in the pedigree and where the data counters comprise one of allele counters to count the frequency of occurrence of a particular allele and haplotype counters to count the frequency of occurrence of a particular haplotype.

The pedigree data structure may further comprise a generator for generating the pedigree data. The pedigree data may be generated according to any one or more of the following processes: random, systematic enumeration of available values, and a strategic combination of pedigree type and genotype data and/or previous samples.

The pedigree data structure may further comprise one or more inheritance generators which may be based on any one or more of the following processes: random, systematic enumeration of available values, and a strategic combination of pedigree type and genotype data and/or previous samples.

The invention has direct application with regard to the estimation of allelic or haplotype probabilities in humans and agricultural species. Embodiments of the invention exhibit the improved ability to detect associations between genes and disease incidence in humans or genes and production traits in livestock.

An advantage of at least one example of the invention is that the time in which pedigree data is processed is significantly improved relative to sequential based processors.

### BRIEF DESCRIPTION OF DRAWINGS

Embodiments of the invention will now be described with reference to the accompanying drawings in which:

FIG. 1 is a schematic illustration of a pedigree data structure held on an FPGA device;

FIG. 2 is a schematic illustration of a first cycle of data held in the pedigree data structure as shown in FIG. 1;

FIG. 3 is a schematic illustration of a second cycle of data in the pedigree data structure as shown in FIG. 1;

FIG. 4 is a schematic illustration of a third cycle of data in the pedigree data structure as shown in FIG. 1;

FIG. 5 is a schematic illustration of the configuration of a descendant module and an associated allele counter, in a first application of an embodiment of the invention;

FIG. 6 is a schematic illustration of the configuration of a descendant module in a second application of an embodiment of the invention;

FIG. 7 is an alternative configuration of a pedigree data structure held on an FPGA device;

FIG. 8 is a schematic illustration of the configuration of a descendant module incorporating allele validity testing in accordance with the embodiment of the invention illustrated in FIG. 7;

FIG. 9 is a schematic illustration of the configuration of a descendant module incorporating allele counting, in accordance with the embodiment of the invention illustrated in FIG. 7;

FIG. 10 is a schematic illustration of an FPGA device showing a first configuration of components for allele inheritance;

FIGS. 11 to 13 schematically illustrate FPGA devices showing a second configuration of components for allele inheritance;

FIG. 14 is a schematic illustration of an FPGA device showing a third configuration of components for allele inheritance; and

FIG. 15 illustrates a schematic illustration of an FPGA device showing a fourth configuration of components for allele inheritance.

### BEST MODE FOR CARRYING OUT THE INVENTION

The basic structure of a field programmable gate array (FPGA) includes an array of configurable logic blocks and a programmable grid of connections that can link the blocks in any pattern a designer chooses. The logic blocks implement the logical functions of gates which act like switches with multiple inputs and a single output. Both the logic functions performed within the logic blocks and the connections between the blocks can be altered by electrical signals. Logic blocks can also be connected to an external memory or microprocessor.

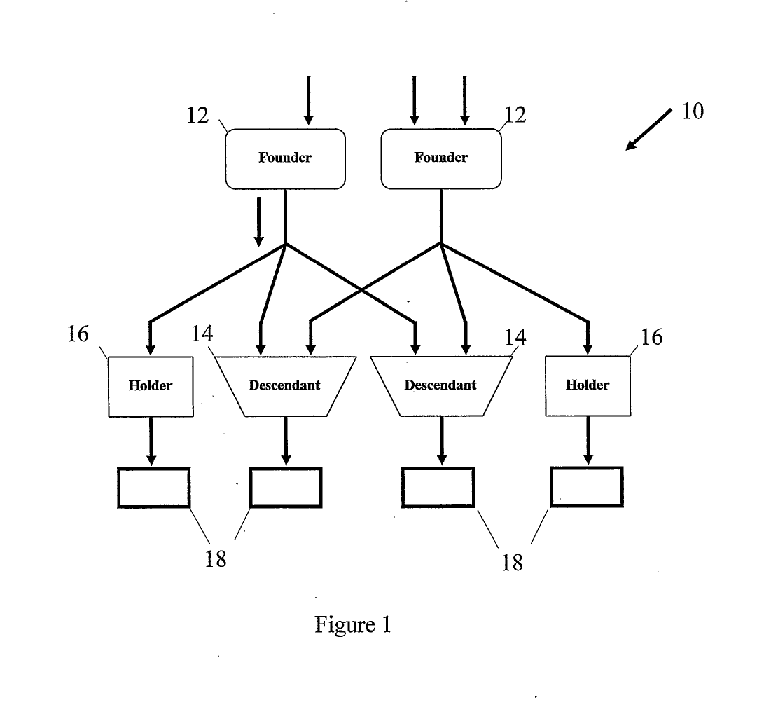

FIG. 1 is a schematic illustration of a pedigree data structure 10 held on an FPGA. Individuals 12, 14 are represented as modules which are arranged in layers. Each layer represents one generation. The structure is arranged so that the complete pedigree receives and processes a first data sample, in the form of alleles, each clock cycle of the FPGA.

Founders 12 reside in layer zero and represent individuals whose parents are unknown. Descendants 14 reside in layer one and represent individuals whose parents are known. Modules in the form of holders 16 also reside in layer one and in this embodiment are required to pass allele information through generations while remaining in synchronicity with the rest of the alleles dropping through the pedigree data structure. Holders effectively function as temporary storage for allelic information from animals higher in the pedigree.

The output from each holder module 16 and descendent 14 is propagated to an allele counter 18 which resides in a terminal layer.

The pedigree data structure 10 is directly mapped into the electronic fabric of the FPGA. Outputs of founder modules 12 are directly wired to the inputs of the descendant modules 14. Clusters of logic cells model each module 12, 14, 16 and the clusters are linked via programmable connections. The logic cells representing the holders 16 are electronic registers and are clocked such that their inputs are stored when the clock signal is received.

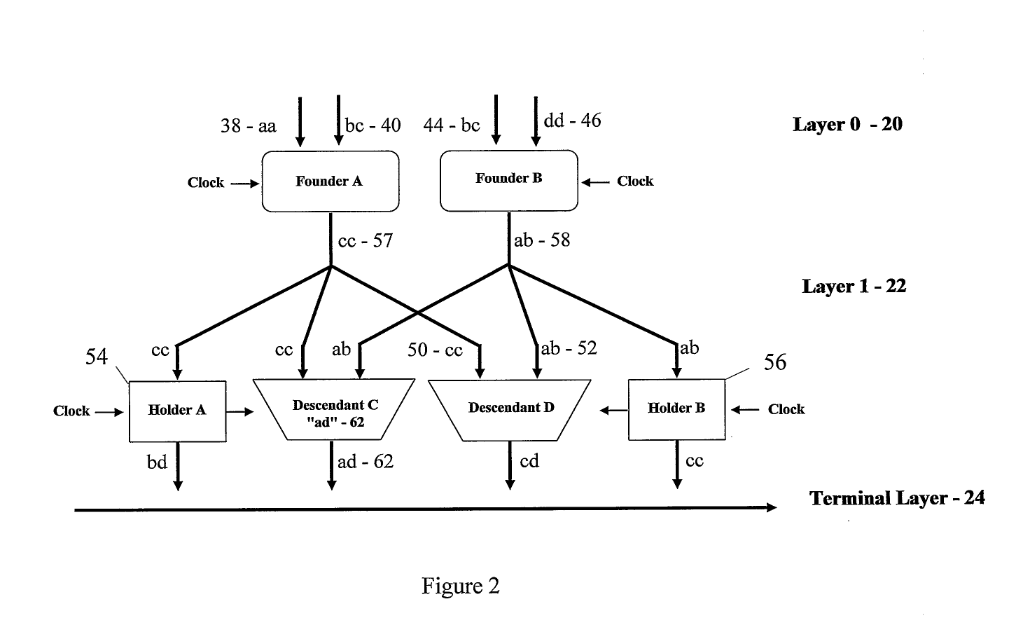

FIGS. 2 to 4 illustrate an example of the transformation of data through three successive clock cycles of the FPGA, so as to estimate allelic probabilities in an agricultural species. At the beginning of each clock cycle, a new data sample of alleles is produced.

A gene dropping algorithm is applied to transmit genes through successive generations and through successive cycles. The way the algorithm works is that for any given cycle, the alleles received by the descendents in ‘layer one’ are the result of a simulated meiosis event from the previous clock cycle at the previous layer. Similarly, the alleles at the terminal layer are the result of a random combination of the paternal and maternal alleles from the previous clock cycle at the previous layer.

Referring first to FIG. 2, four individuals A, B, C and D are represented spanning two generations. Individuals C and D are the descendants of individuals A and B. Individuals A and B reside in layer zero, designated by reference number 20, and individuals C and D reside in layer one designated by reference numeral 22. Below layer one is a terminal layer 24, a bus to pass the received data to allele counters. Each individual has an associated allele counter which stores the processing of results for the respective individual.

Since the parentage of individuals A and B is unknown, a random number generator is used to generate paternal and maternal allele pairs for input into individuals A and B at layer zero 20. This occurs at the start of the clock cycle. The random number generator operates to convert random binary numbers into combinations of alleles which are supplied according to a probability ratio input by the user. The random number generator is implemented in the logic circuitry of the FPGA. Allele pairs “aa” 38, and “bc” 40, are generated for individual A whilst allele pairs “bc” 44, and “dd” 46, are generated for individual B.

The alleles at layer one, “cc” 57, and “ab”, 58 are the result of a combination of the simulated paternal and maternal alleles from the previous clock cycle (not shown) at the previous layer (not shown).

At the end of the clock cycle, allele data “cc” 57, is transferred to its descendents, individuals A and B, and to individual A's holder module 54. Similarly allele data “ab” 58 is transferred to its descendents, individuals A and B, and to individual B's holder module 56. The holder modules 54, 56 ensure that the transmission of pedigree data through a generation occurs in parallel in the same clock cycle.

With regard to individuals C and D, the alleles output to the terminal layer are again the result of a combination of the simulated paternal and maternal alleles from the previous clock cycle at the previous layer. With regard to the holder modules 54, 56, the alleles output to the terminal layer is the allele received by the holder in the previous cycle.

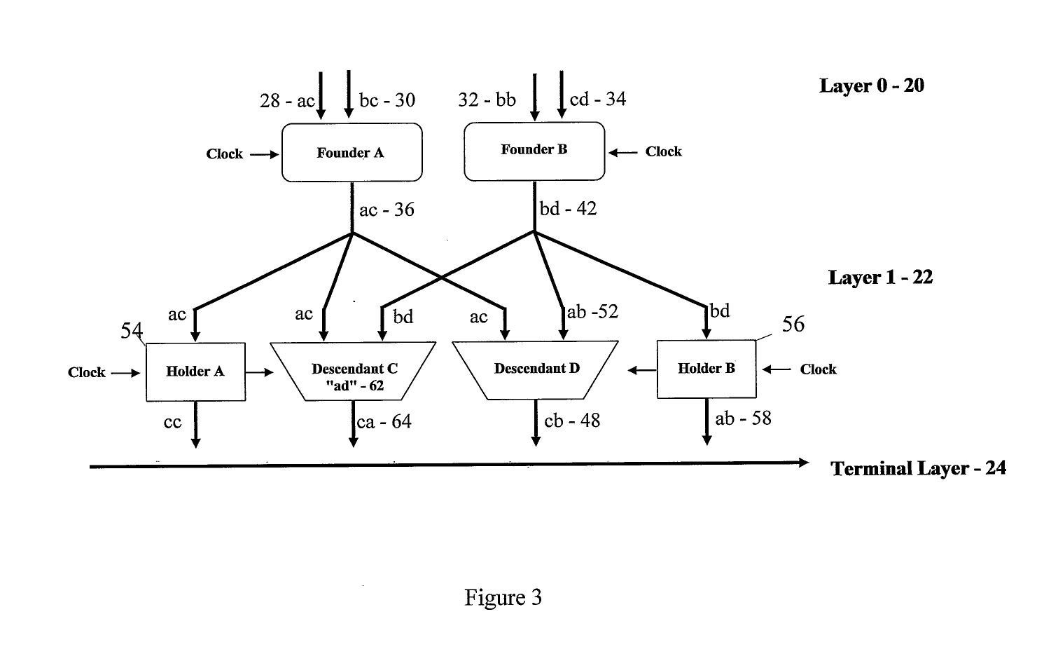

We now refer to the second clock cycle illustrated in FIG. 3. At the start of the clock cycle allele pairs “ac” 28, and “bc” 30, are generated to represent paternal and maternal alleles for individual A whilst allele pairs “bb” 32, and “cd” 34, are generated to represent paternal and maternal for individual B.

The alleles at layer one, 22, are the result of a simulated meiosis event from the previous clock cycle (FIG. 2) at the previous layer (layer zero, 20). For instance, alleles “ac” 36, are produced as a result of combining “a” from the “aa” 38, paternal line and “c” from the “bc” 40, maternal line of individual A in the previous cycle.

At the end of the clock cycle, allele data “ac” 36, is transferred to its descendents, individuals C and D, and to individual A's holder module 54. Similarly allele data “bd” 42, is transferred to its descendents, individuals C and D, and to individual B's holder module 56.

The alleles output from the descendents at the terminal layer 24 in FIG. 3 are the result of a random combination of the paternal and maternal alleles from the previous clock cycle (FIG. 2) at the previous layer (layer one, 22). For example, descendent D's alleles “cb” 48, are the result of combining, from individual A, “c” from the “cc” 50, and from individual B, “b” from the “ab” 52.

With regard to holder module 56, the allele “ab 58 output to the terminal layer, is the allele received by the holder module 56 in the previous cycle.

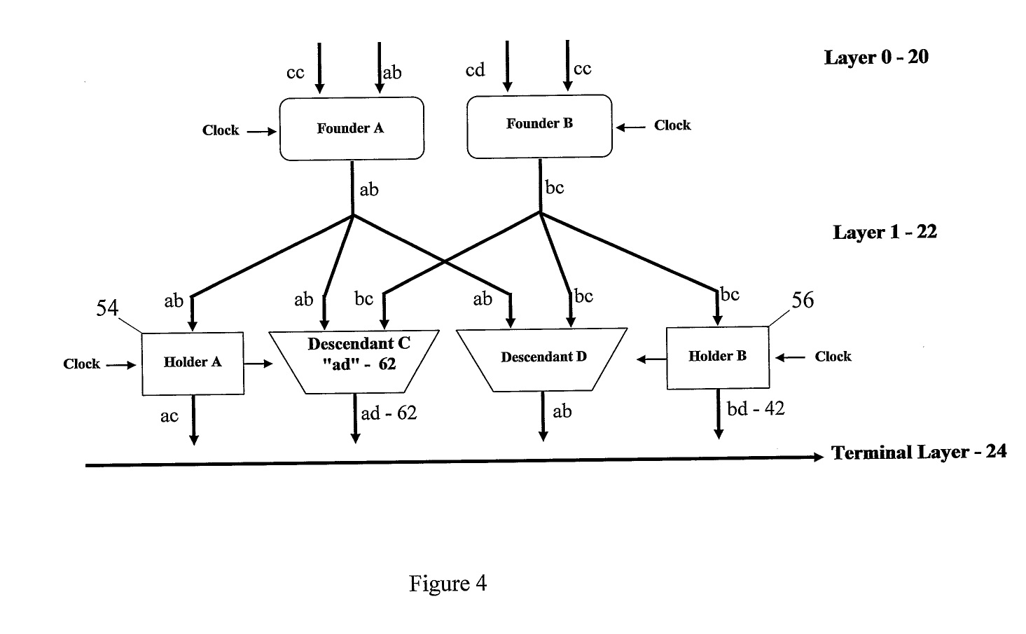

Similarly, with regard to holder module 56 as illustrated in the third cycle (FIG. 4), the allele “bd 42 output to the terminal layer, is the allele received by the holder module 56 in the previous cycle

Allelic probabilities for the pedigree are estimated by accumulating those samples that are consistent with the observed data. Since only descendent C's allelic information is known, only descendant C is tested to determine whether the allele generated matches the known allele “ad” 62.

This condition was satisfied with cycles one and three. Therefore the frequency of the alleles for each of the individuals in cycles one and three are counted. For the case of cycle two, the allele generated “ca” 64, does not match the known allele “ad” and therefore the whole set of alleles is rejected.

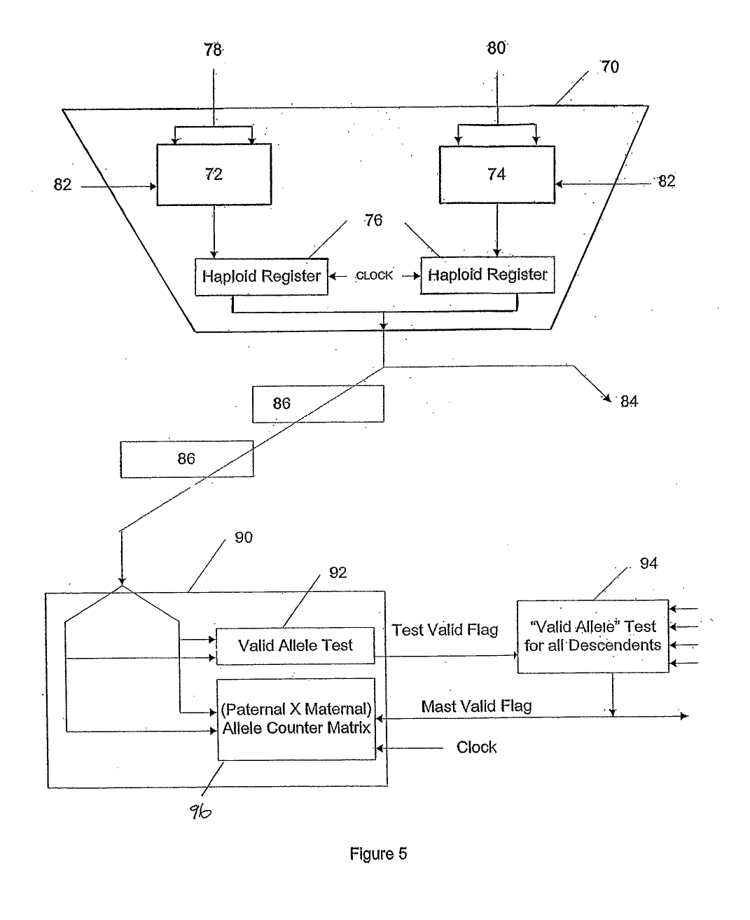

FIG. 5 illustrates more generally the configuration of a descendent module 70 and an associated allele counter 90 which tests and counts for valid allele configurations. A single individual, itself a descendent 70, is shown and is configured with a pair of switches 72 and 74 and a pair of haploid registers 76. Paternal alleles 78 and maternal alleles 80 are input into switches 72 and 74 respectively, each which are the result of a simulated meiosis event from a previous clock cycle. In addition, each switch receive a signal from an inheritance generator 82.

Alleles from each haploid register 76 are combined and passed to first generation descendents 84 of individual 70. In addition the pair of alleles are propagated via holder modules 86 to the terminal layer, the number of holder modules (n−1) dependent on the number of generations n.

Having propagated through the holder modules 86, the allele data is passed to the allele counter 90 and the data is split into its paternal and maternal gene. If the data relates to an individual whose actual allele data is known, then the data is tested 92 to determine its validity. The output of the validity test is passed to a comparator 94. The comparator 94 receives the validity results from all allele counters. The valid allele signals from all descendants are compared and only if the validity results are all valid is the master valid signal set to ‘ON’, allowing the count of all alleles in the sample to proceed. In this case, in each allele counter 90, the particular cell in the allele counter matrix 96, for the particular combination of paternal and maternal gene, is incremented by one.

Data from each cell in the matrix is then read out to a PC for analysis.

The configuration of the founder modules is identical to descendant modules apart from the source of alleles.

A test experiment was performed on an eleven individual pedigree, with four alleles of equal frequency in layer zero and with genotypes assumed known for four of the individuals. A Xilinx Spartan 3 FPGA operating at 50 MHz was used for the FPGA computations. The FPGA was configured using VHDL, generated by a software-based pedigree interpreting tool, performing pre-processing on the pedigree data to identify valid and invalid allele combinations. The Allele and Inheritance Generators were based on a Cellular Automata Random Number Generator, chosen because of its suitability for implementation on an FPGA, as well as its ability to produce high quality pseudo-random numbers.

A new sample was produced per clock cycle. The results were compared against the use of a general purpose computer processing unit (CPU) whereby the data was processed sequentially, see table 1. The speed advantage of the FPGA over the general purpose CPU was 295 times, when adjusted for the clock speeds of the fastest available FPGA and general purpose CPU. This margin increased to 495 times with a twenty individual pedigree that included one additional individual with known genotype.

TABLE 1
Comparison of FPGA and general purpose CPU:
estimating genotype probabilities

| | | | Speed | | | Speed |
|---|---|---|---|---|---|---|
| number of | Valid | Valid | advantage | Valid | Valid | advantage |
| individuals | samples/s | samples/s | for FPGA | samples/s | samples/s | for FPGA |
| in the | (3.0 GHz | (50 MHz | using test | (3.8 GHz | (390 MHz | using test |
| pedigree | Pentium) | FPGA) | systems | Pentium)*# | FPGA)# | systems*# |
| 11 | 127 | 6,100 | 48 | 161 | 47,600 | 295 |
| 20 | 8 | 635 | 80 | 10 | 4,950 | 495 |

#Estimated by extrapolation
*Maximum clock speed estimate is 390 MHz for Xilinx Virtex 4 devices.

The application of the first example of the invention concerned the estimation of genotype probabilities in an agricultural species. A second application concerns the estimation of inbreeding coefficients in an agricultural species. The coefficient of inbreeding (F) for an individual is the probability that the alleles carried at a random location on the genome are identity by descent (IBD).

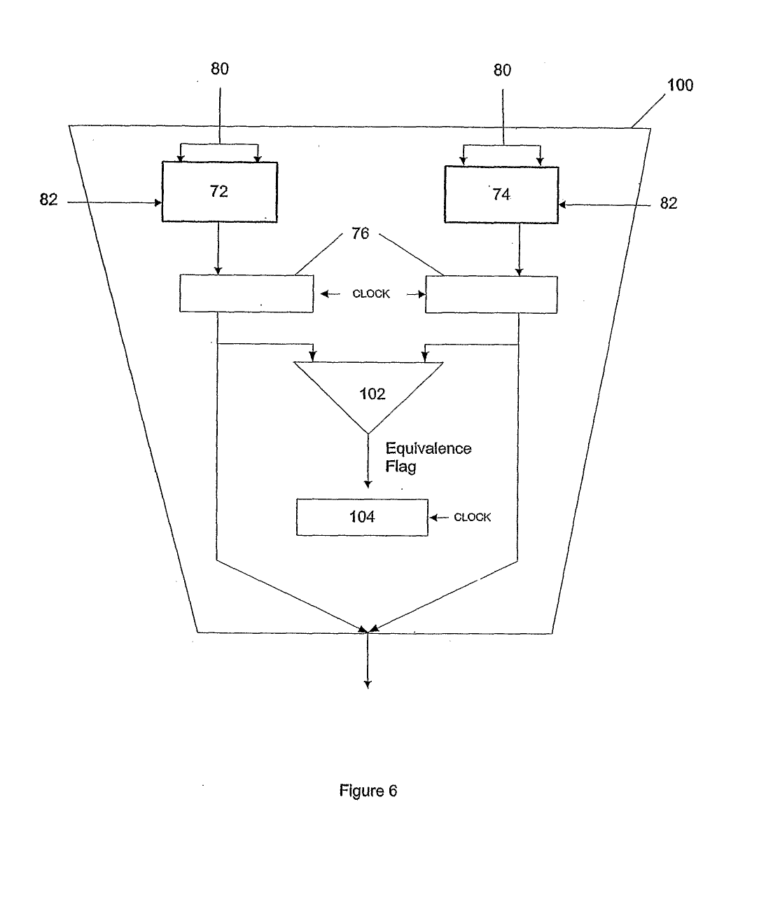

FIG. 6 illustrates the structure of a descendant module 100 for this application. The initial structure of the descendent module 100 has the same configuration as the structure for the descendent module for calculating genotype probability. However there are two differences. Located within each descendant module 100 is a comparator 102 to check whether the alleles are IBD and a counter 104 to increment when they are IBD.

Founder modules are assigned a constant pair of alleles, with only one copy of each allele occurring in layer zero. Meiosis events can be either pseudo random or, if the space is small enough, the complete set of possible meiosis events can be enumerated to produce an exact solution. When programmed on an FPGA the allele transmission between parents and offspring, the comparison for all individuals and the incrementing of the counters all take place in a single cycle of the system clock. As new alleles enter at the top of the pedigree each clock cycle, a new sample for the whole pedigree is obtained. This is regardless of the number of the individuals in the pedigree, provided that the FPGA is large enough to store all of the animals.

For this application a test experiment was performed on a sixty individual pedigree and fifty million samples were obtained per second. Comparatively, a sequential version of the algorithm on a general purpose CPU generated 301,000 samples per second, see table 2. It is estimated that using a high performance FPGA, 390 million samples per second could be generated, giving a 1000 times speed advantage over a 3.8 GHz CPU. This advantage only increases as more individuals are added to the pedigree. By extrapolation, it is estimated that the largest FPGA's recently announced could store more than 2,000 individuals and yield an improved performance factor of 36,000 times that of the general purpose CPU.

TABLE 2
Comparison of FPGA and general purpose CPU: estimating inbreeding coefficients

| | | | | | | Speed |
|---|---|---|---|---|---|---|
| number of | | | Speed advantage | | | advantage |
| individuals | Samples/s | Samples/s | for FPGA | Samples/s | Samples/s | for FPGA |
| in a | (3.0 GHz | (50 MHz | using test | (3.8 GHz | (390 MHz | using test |
| pedigree | Pentium) | FPGA) | systems | Pentium)# | FPGA)# | systems*# |
| 32 | 582,000 | 50 × 10⁶ | 86 | 737,000 | 390 × 10⁶ | 530 |
| 60 | 301,000 | 50 × 10⁶ | 166 | 380,000 | 390 × 10⁶ | 1,030 |
| 1,000 | 17,500 | 50 × 10⁶ | 2,860 | 22,150 | 390 × 10⁶ | 17,500 |
| 2,000 | 8,570 | 50 × 10⁶ | 5,830 | 10,860 | 390 × 10⁶ | 36,000 |

#Estimated by extrapolation
*Maximum clock speed estimate is 390 MHz for Xilinx Virtex 4 devices.

In a further embodiment the pedigree data structure may comprise modules containing subsets of the structure and logic required to perform operations on that subset. These operations on the subset and therefore the entire structure may take more than one clock cycle per sample. Such an embodiment has the advantage of being able to store and process a greater number of individuals than with the direct mapping approach described and illustrated with respect to FIGS. 1 to 6. Individual processors may signal a ‘ready flag’ to indicate completion of its operations. Receiving processors waiting for the signal of the ready flag are then able to commence reading of the data. Data may be passed between processors with the aid of a register.

In applications involving multi-locus modules, recombination events may affect the likelihood of samples. In such examples each descendent module may further include a Metropolis-Hastings accept/reject step. Optionally, if the complete set of meioses is enumerated, samples may be weighted by the likelihood to produce an exact solution.

In the described, or alternative embodiments, the inheritance generators may be modified to enable multiple markers to be inherited according to known ratios between the likelihood of adjacent markers being inherited.

In the described, or alternative embodiments, the random generators may be modified to avoid the propagation of alleles which are known to be invalid.

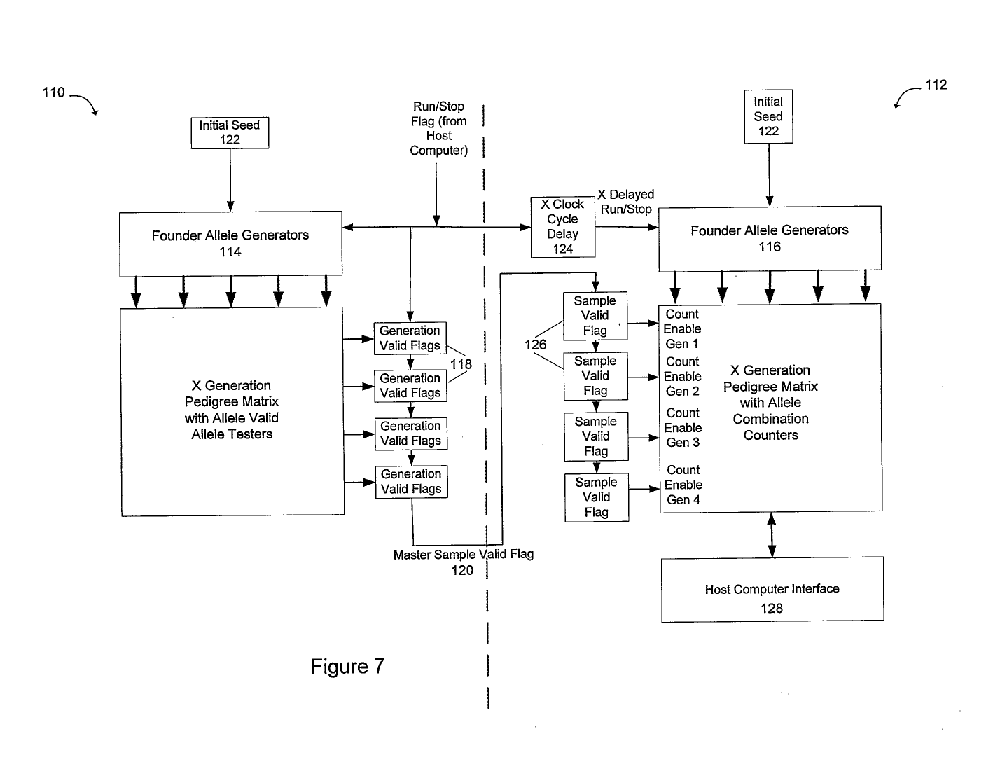

An alternative embodiment of a pedigree data structure held on an FPGA is illustrated in FIGS. 7 to 9. In this embodiment the pedigree under examination is represented twice, with each representation mapped into the electronic fabric of a separate FPGA 110, 112. A simple electronic connection facilitates communication between the FPGAs.

Similar to FIG. 1, each FPGA 110, 112 represents individuals in the pedigree structure as modules which are arranged in layers, each layer representing a single generation (not shown). The structure is arranged so that the complete pedigree receives and processes a first data sample, in the form of alleles, each clock cycle of the FPGA. Each FPGA include a pseudo-random number generator 114, 116 implemented in the respective logic circuitry.

Each module of the first FPGA 114, includes a validity tester (not shown). The validity tester flags “true” for any combination of alleles that are possible for the individual represented by that module. Each generational row of individuals connects the Valid flags via an AND gate to provide a “Generation is valid” flag 118. The flag 118 is combined via a two-input AND gate with the results of the previous generation one clock-cycle ago. The resulting signal is propagated, with the rest of the individuals tested for validity, until a final “Master Valid Flag” 120 will signal true or false to indicate if all, or not all, of the alleles for the individuals are acceptable.

The Master Valid flag is then passed onto the second FPGA 112. Each module of the second FPGA 112 includes an allele counter (not shown). By using the same seed 122 for the pseudo-random number generator 116 as for the generator 114 in the logic circuitry of the first FPGA 110, the alleles generated are exactly the same as the first FPGA's alleles. However, the second FPGA 112 is delayed by X clock cycles after the first FPGA 110, by clock cycle delay logic 124, X being the number of generations in the pedigree. The decision whether to count or not is determined by the single bit, “Master Sample Valid Flag” 126. This flag is propagated through each generation of the pedigree by one generation per clock cycle. Finally at the end of the sample run, a host computer (not shown) reads the results from the allele counters of the second FPGA via a host computer interface 128.

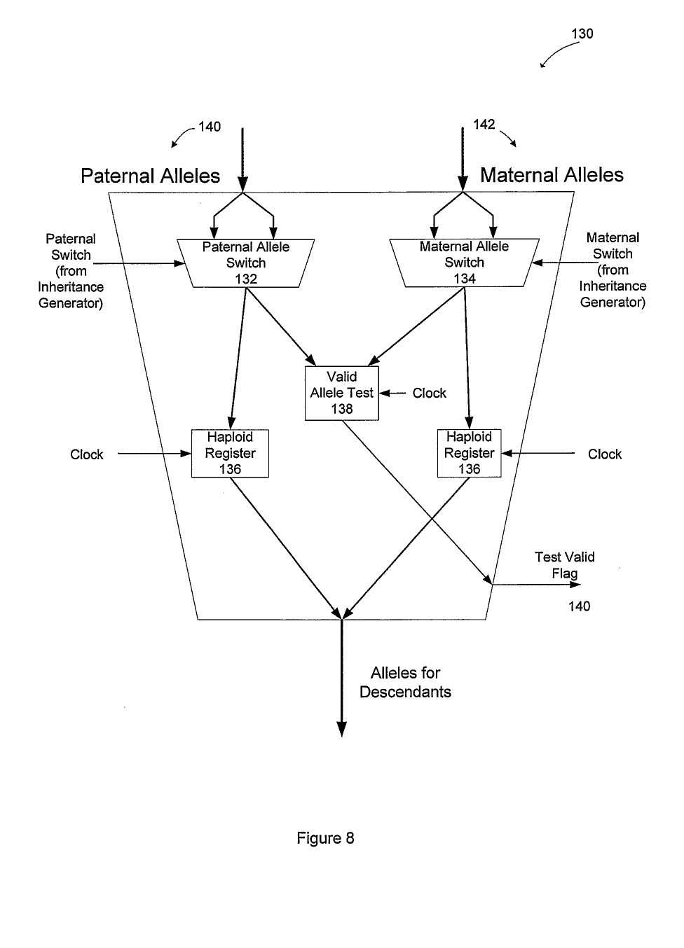

FIG. 8 illustrates more generally the configuration of a descendent module 130 of the first FPGA 110 for testing allele validity. The basic structure is essentially the same as that shown in FIG. 5. A single individual, itself a descendent 130, is shown and is configured with a pair of switches 132 and 134 and a pair of haploid registers 136. In addition, the descendent module 130 is configured with an allele validity tester 138. Paternal alleles 140 and maternal alleles 142 are input into switches 132 and 134 respectively, each which are the result of a simulated meiosis event from a previous clock cycle. In addition, each switch receives a signal from an inheritance generator. Alleles from each haploid register 136 are combined and passed to first generation descendents of individual 130. The allele data is also passed to the allele validity tester 138. So long as the data relates to an individual whose actual allele data is known, then the data is tested to determine its validity. The test validity flag 140 is flagged “true” for any combination of alleles that are possible for the animal represented by that module.

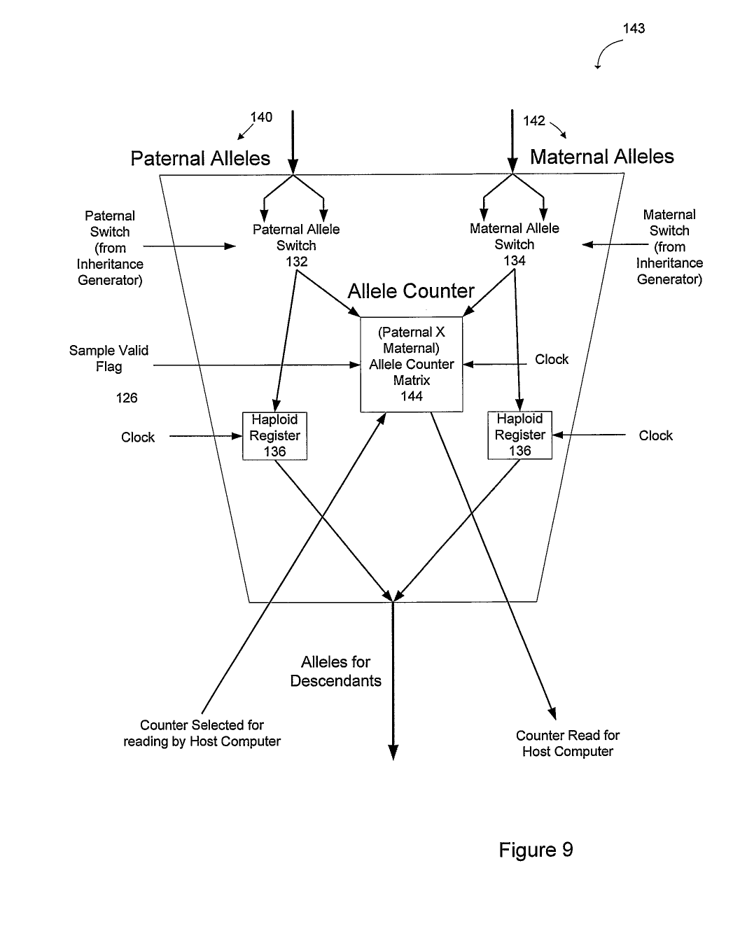

FIG. 9 illustrates more generally the configuration of a descendent module 142 of the second FPGA 112 for allele counting. The basic structure of the module 142 is the same as the module 130, in which like numbers refer to like elements, except the allele validity tester 138 is replaced with an allele counter 144. As previously stated, the decision whether to count or not is determined by the Master Sample Valid Flag which is propagated 126 through each generation of the pedigree by one generation per clock cycle. The output is read by the host computer (not shown).

An advantage of this approach is that it allows the processing of pedigrees of a size larger than those feasible with a single FPGA as only valid samples are stored.

The approach is also very suitable for methods applying algorithms such as the Metropolis Hastings algorithm, as described in “Equations of State Calculations by Fast Computing Machines” Journal of Chemical Physics, 21:1087-1092, 1953, the contents of which are incorporated herein.

In examples where for all animals, for all loci, no inconsistency between observed genotypes and sampled alleles occurs, counters for the sampled alleles must be incremented for all animals and loci.

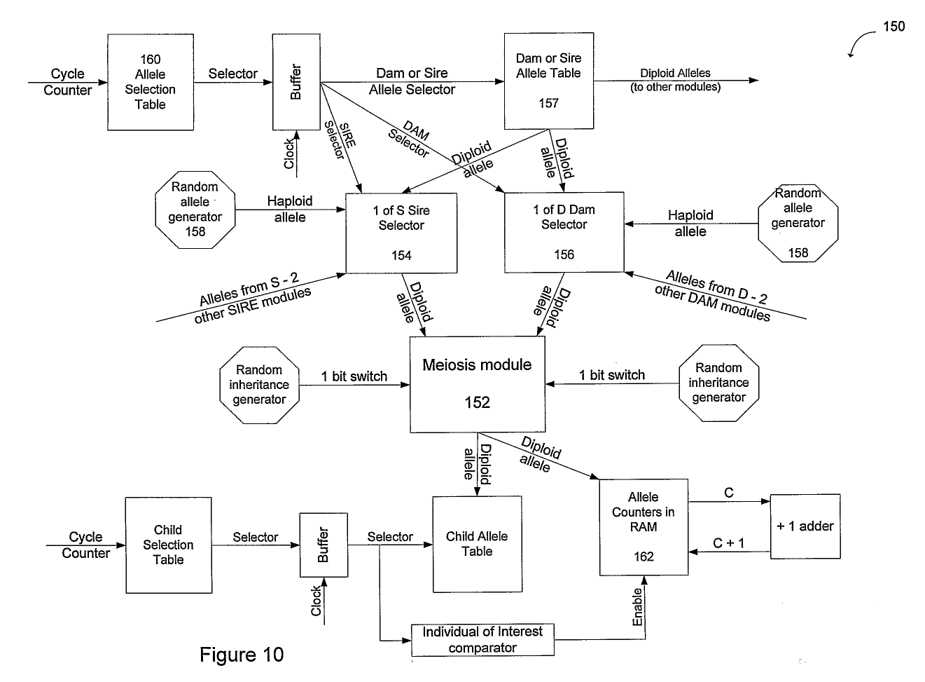

FIGS. 10 to 15 illustrate more generally, alternative configurations of components for allele inheritance.

FIG. 10 is a schematic illustration of components which are mapped into the fabric of an FPGA 150. Central to the FPGA 150 is a central meiosis module 152 which is as described in FIG. 1. The input to the meiosis module 152 is determined by the paternal, or sire, selector 154 and the maternal, or dam, selector 156. In the instance that there are more individual modules than there are inputs that are able to be selected, each individual module would be assigned only S-2 other modules for the Sire, and up to D-2 other inputs for the Dam. Dam or Sire alleles can also be input from within the module having been selected from the Dam or Sire allele table 157, or they can be generated randomly 158.

An allele selection table 160 is provided which selects the correct Sire and Dam alleles, or selects the module in question to find the Sire and/or Dam allele from another module. Allele counters 162 store the occurrences of each allele combination, for each generation.

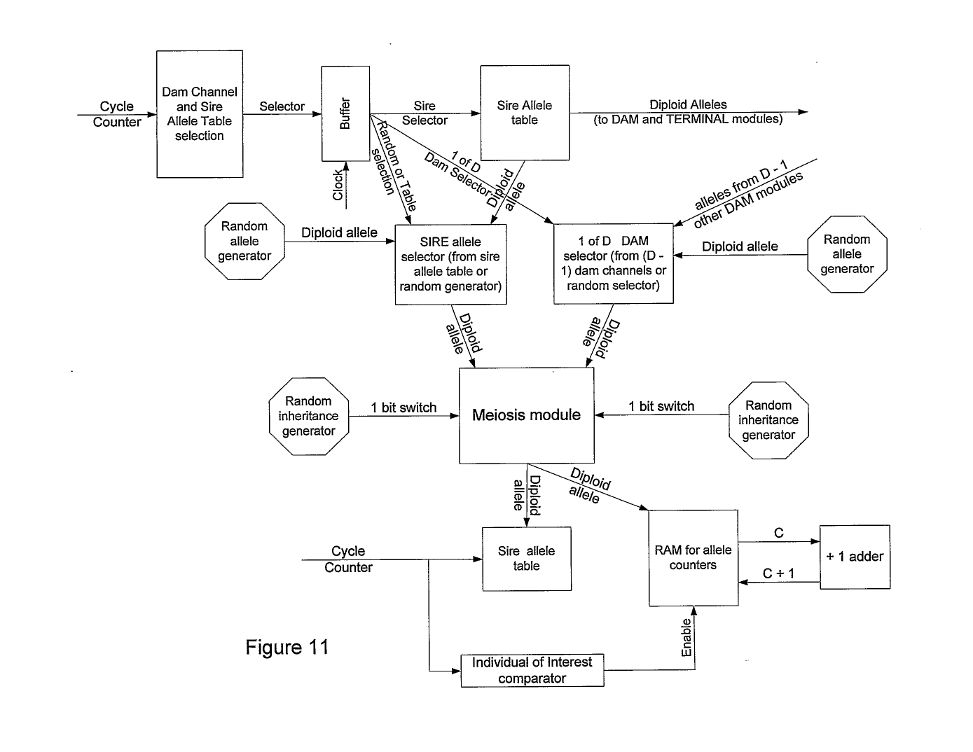

FIGS. 11 to 13 relate to an alternate embodiment for allele inheritance where the inheritance modules (also called channels) are tailored for three types of individuals:

Sires—those individuals that are sires of other individuals in the pedigree

Dams—those individuals that have are dams of other individuals in the pedigree

Terminals—those individuals that have no descendants in the pedigree

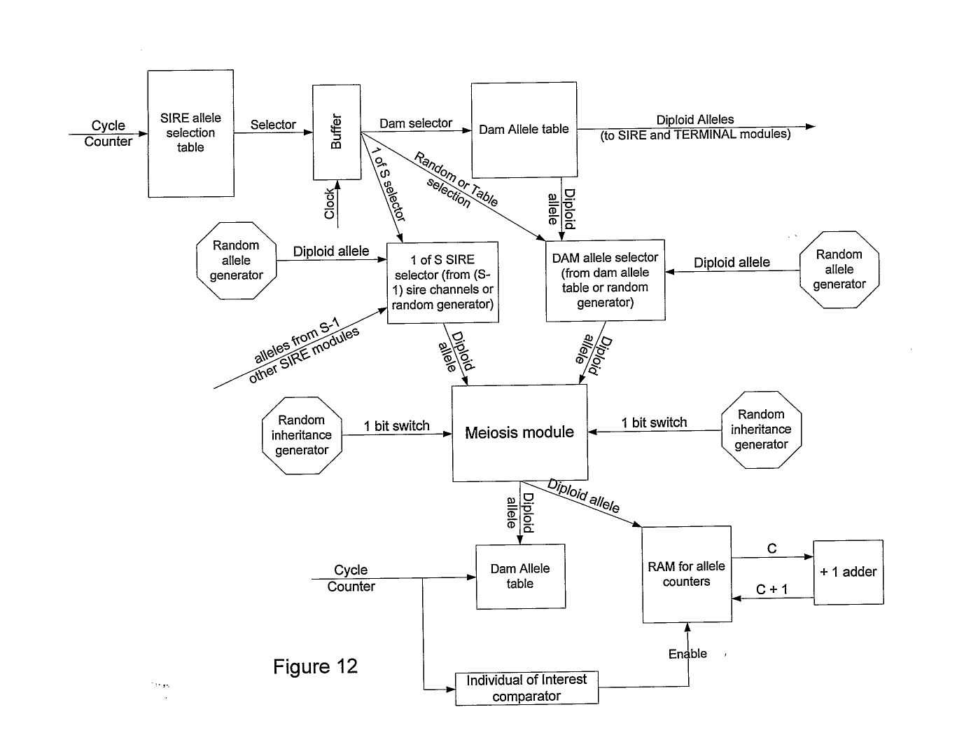

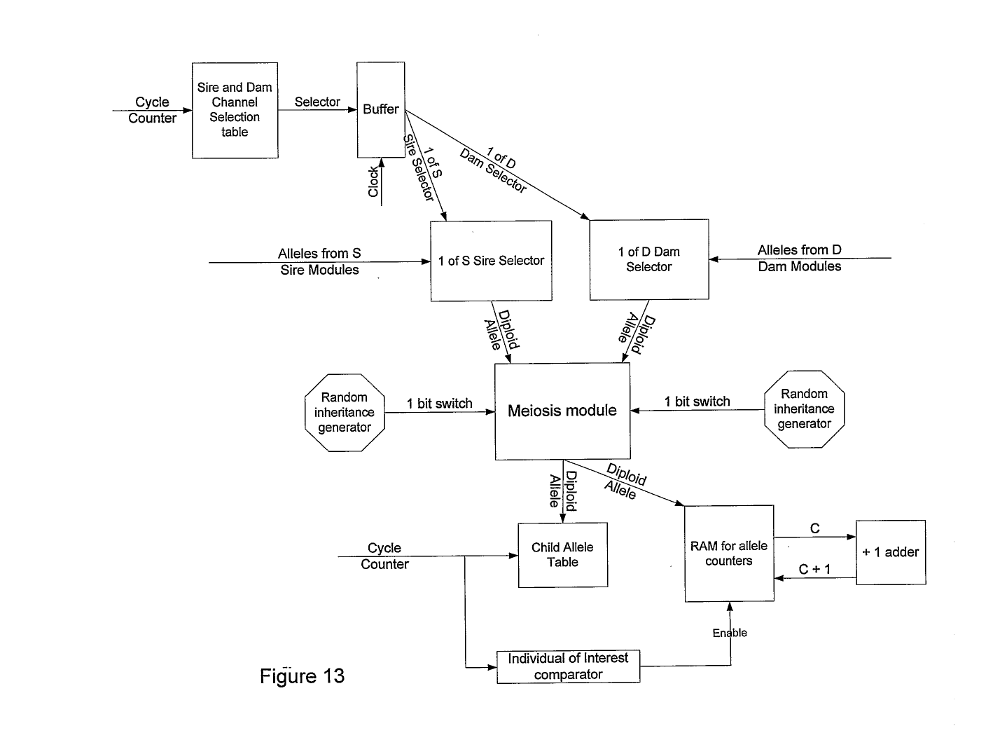

With the specialization of modules, Sires—as illustrated in FIG. 11, Dams—as illustrated in FIG. 12, Terminals—as illustrated in FIG. 13, the size of the input switches can be tailored. For example there will typically be fewer sires in an individual pedigree, and so the size of the Sire allele selector can be smaller. Furthermore the Sire allele selector need only connect to other Sire Modules. Likewise the Dam allele selector need only connect to Dam Modules.

In accordance with this embodiment data is transmitted for just the one generation per cycle, then it changes the Selectors in preparation for the next generation. For example, if there are ten generations, it would take ten cycles to scan the whole pedigree. Although slower than the embodiment described in relation to FIGS. 1 to 6 a greater number of individuals can be mapped on a single device.

In any of the above embodiments, a “Supervisor” soft processor can be mapped into the electronic fabric of each FPGA to communicate between the host PC and the respective mapping tables to enable re-configuration of the FPGA for different pedigrees and reading results. In other embodiments, a single pedigree can span many FPGA's with some Channels receiving their alleles from other Channels on other FPGA's rather than channels on the same FPGA. Alternatively, Sire Modules, being the least numerous, can be reproduced on alternative FPGA's.

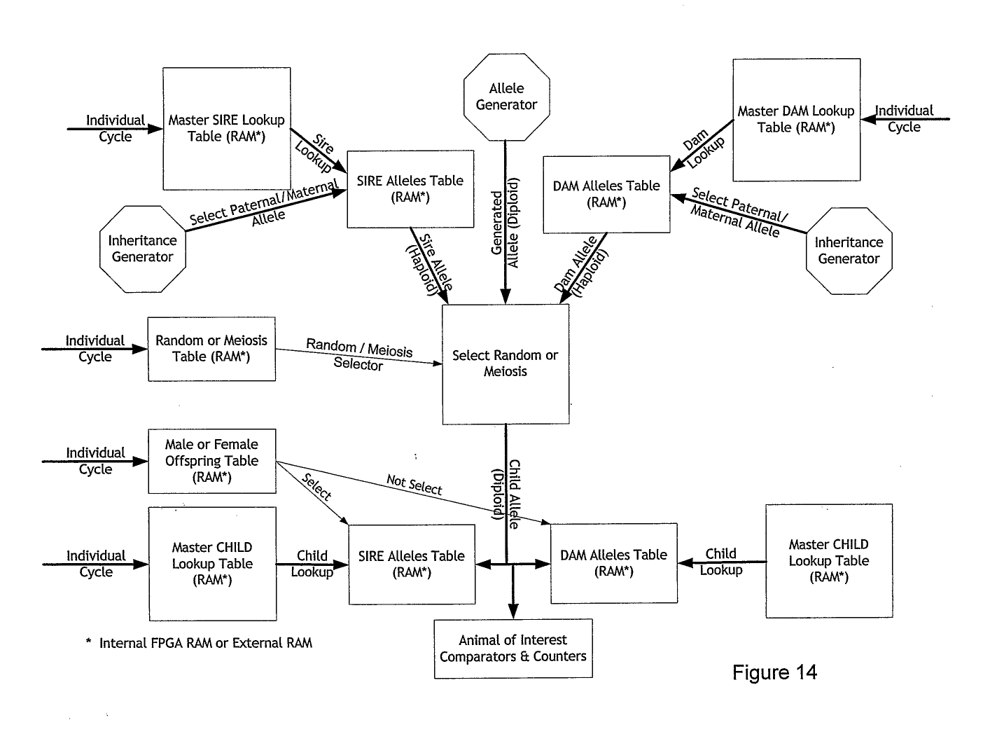

FIG. 14 illustrates components of an FPGA to enable acceleration of the estimation of allele probabilities. This method is based upon a sequential scan through the pedigree and essentially the performance improvement is achieved by duplicating the storage of inter-generational allele values in memory. As a result, many simultaneous sequential scans through the pedigree occur in parallel.

In this embodiment a plurality of copies of a pedigree data structure are mapped into the electronic fabric of the device. Each module representative of the same individual in each pedigree receives data simultaneously for each sampling cycle. A common lookup table is required to provide the addresses of parents and describe the pedigree relationships for all modules. A common “Individual Cycle” counter keeps each module in sync, albeit with different genetic data being transmitted for each module.

With the use of high capacity off-FPGA memory, lookup tables for pedigrees with up to hundreds of millions of individuals are possible. FPGA block RAM can be used to increase the number of simultaneous scans, at the expense of pedigree size.

The advantage of this embodiment is its ability to use large amounts of memory external to the FPOA (or ASIC). If such memory is used, up to millions of individuals might be processed, otherwise only 1,000's to 100,000's of individuals could be processed on FPGA—the trade-off of size being speed. This technique is the most promising for processing livestock data because of its potential capacity.

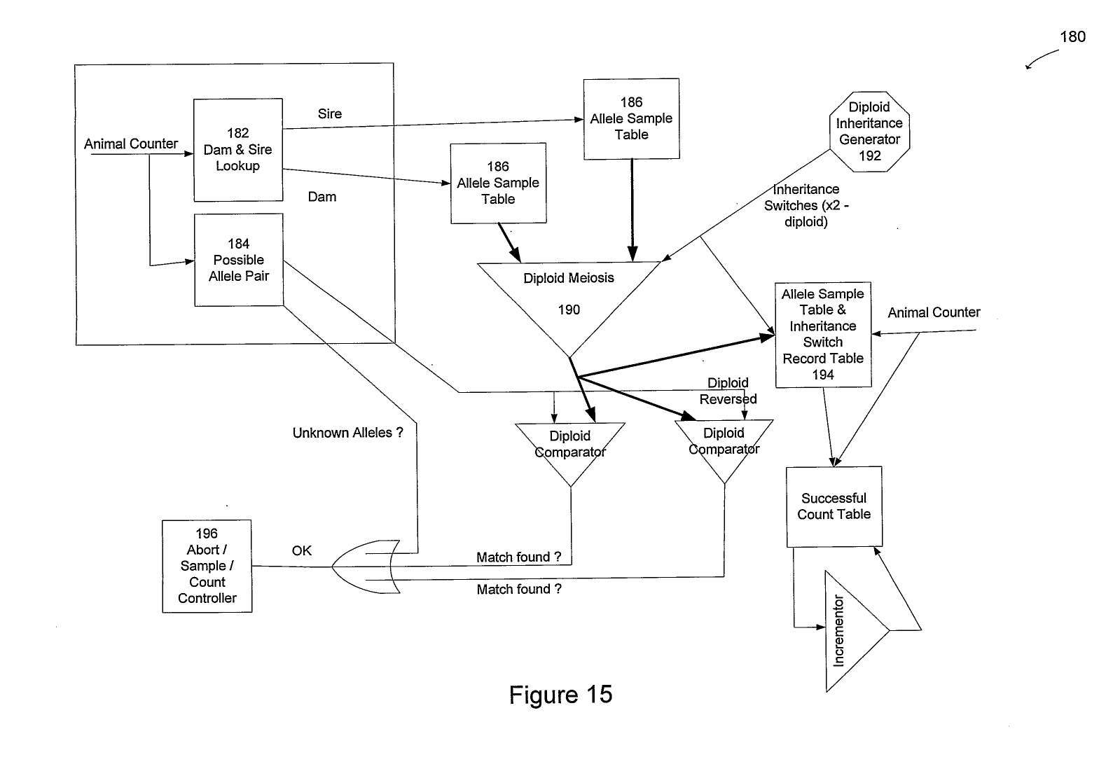

FIG. 15 illustrates components of a FPGA for allele inheritance where the components have been optimized to maximize the number of successful samples in any given time period. A first memory block 182 contains the pedigree (Sire and Dam pointers) of the individuals. A second memory block 184 contains any allele pairs that may be known. If none are known, an “Unknown flag” is set. A further memory block, “the Allele Sample Table” 186 is used to store the temporary allele samples generated.

In use, the animals are scanned from oldest to youngest. A record of the alleles generated by meiosis 190 and the inheritance switches 192 are stored in the “Allele Sample Table & Inheritance Switch Record Table” 194. This is called the Sampling Super Cycle. Any allele combinations generated that do not satisfy the known alleles will set the OK flag to false. When this occurs, the sample is immediately aborted 196, and the count begins from the first animal again. If a sample completes without aborting, the Sampling Super cycle pauses while a Count Super Cycle commences. The Count Super Cycle reads through each allele and Inheritance switch values saved in the Allele Sample Table and Inheritance Switch Record Table, and adds the occurrence of each to the Successful Count Table 198.

With the ability to count the Inheritance switches, it is possible to bias the Inheritance generators to give more samples in the direction of successful allele drops, and weight accordingly. One or more “master” general purpose processors (not shown) supervise this process. This has the advantage of significantly increasing the success rate of samples, which in turn provides more information about likely allele paths, and further biasing would ensue to accelerate the process.

It is assumed that alleles are to be stored and counted for all animals, but in practice there is no need to store the alleles for terminal animals that are not the subject of interest.

The sequential algorithm is very efficient on resources since it can utilize FPGA block memory for the storing of the pedigree. Resulting inherited alleles can also be stored in the memory blocks.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A device, namely, one of a Field Programmable Gate Array (FPGA) device and an Application Specific Integrated Circuit (ASIC), configured to represent one or more pedigree data structures, each structure including at least two generations, the device comprising:
a plurality of logic cells arranged such that one or more of the logic cells model a module of the pedigree data structure, where each module of the pedigree data structure is representative of an individual in a pedigree;
input circuitry to receive pedigree data and output circuitry to output processed data; and
electrical connections between the logic cells and the input and output circuitry;
where the arrangement of the logic cells and electrical connections enable parallel processing on a loaded pedigree data structure such that the transmission of pedigree data through at least a subset of the, or each, pedigree data structure occurs in each sampling cycle.

2. A device according to claim 1, where the subset of the pedigree data structure comprises a generation of the pedigree.

3. A device according to claim 1, where at least the subset of the pedigree data structure comprises all generations of the pedigree.

4. A device according to claim 1, where the subset of the pedigree data structure comprises any number of individuals within the pedigree.

5. A device according to claim 1, where duplicate copies of a pedigree data structure are represented on the device and the subset of each pedigree data structure comprises an individual of each pedigree.

6. A device according to claim 1, where duplicate copies of a pedigree data structure are represented on the device and the subset of each pedigree data structure comprises two or more individuals of each pedigree.

7. A device according to claim 1, where each sampling cycle comprises a number of clock cycles.

8. A device according to claim 7, where each sampling cycle comprises two clock cycles.

9. A device according to claim 8, where each sampling cycle comprises a single clock cycle.

10. A device according to claim 1, where at least a pair of modules are representative of at least a pair of holder modules such that pedigree data is passed through the subset of the pedigree data structure while remaining in synchronicity with the rest of the data dropping through the pedigree data structure.

11. A device according to claim 1, where the modules comprise founder modules for representing individuals whose parents are unknown and descendant modules for representing individuals whose parents are known.

12. A device according to claim 1, further comprising a plurality of data counters, where each data counter is representative of an individual in the pedigree and where the data counters comprise one of allele counters to count the frequency of occurrence of a particular allele and haplotype counters to count the frequency of occurrence of a particular haplotype.

13. A device according to claim 12, where each data counter includes a data authenticator operable to check received data against known data and to output a signal indicative of whether the received data for the individual is representative of the individual.

14. A device according to claim 13, further comprising a filter associated with the data authenticator, the filter operable to reject the entire sample if the propagated data for any one of the individuals is inconsistent with the known data.

15. A device according to claim 1, further comprising a generator for generating the pedigree data.

16. A device according to claim 1, further comprising an inheritance generator for generating inheritance data, where the generation of data is based on one of the following processes, random, systematic enumeration of available values, and a strategic combination of pedigree type and genotype data and/or previous samples.

17. A method for processing pedigree data, the method comprising:
representing one or more pedigree data structures in one of a Field Programmable Gate Array (FPGA) device and an Application Specific Integrated Circuit (ASIC), each structure comprising at least two generations; and
operating on the, or each, pedigree data structure in parallel such that transmission of pedigree data through a subset of the pedigree data structure occurs in each sampling cycle.

18. The method according to claim 17, further comprising translating pedigree data into a structure for mapping into the electronic fabric of the FPGA device or the electronic fabric of the ASIC.

19. The method according to claim 18, where mapping into the electronic fabric FPGA includes configuring clusters of logic cells of the FPGA to represent individual components of the data structure and programming connections between the clusters.

20. The method according to claim 17, further comprising generating the pedigree data.

21. The method according to claim 20, where generating the pedigree data occurs according to a process selected from random generation, systematic enumeration of available values, and a strategic combination of pedigree type and genotype data and/or previous samples.

22. The method according to claim 20, further comprising weighting the generated data according to user-defined proportions.

23. The method according to claim 20, further comprising generating a new sample of pedigree data for each sampling cycle.

24. The method according to claim 17, where operating on the pedigree data structure comprises propagating each sample of pedigree data from one generation to the next.

25. The method according to claim 17, where duplicate copies of a pedigree data structure are represented and operating on each of the pedigree data structures comprises propagating pedigree data through an individual of each pedigree.

26. The method according to claim 24, further comprising authenticating propagated data against known data and outputting a signal indicative of whether the propagated data for an individual of the pedigree is representative of the individual.

27. The method according to claim 26, further comprising rejecting the entire sample if the propagated data for any one of the individuals is inconsistent with the known data.

28. The method according to claim 24, further comprising translating the propagated data into a form suitable for analysis, to determine, at least one of, the estimation of allelic probabilities, the estimation of haplotype probabilities and the calculation of inbreeding coefficients.

29. A pedigree data structure held on one of a Field Programmable Gate Array (FPGA) device and an Application Specific Integrated Circuit (ASIC), the structure comprising:
a plurality of modules each representative of an individual in the pedigree;
where one or more electrically connected logic cells of the FPGA, or ASIC, model each module of the pedigree data structure, and where the modules are configured to enable operation on the pedigree data structure in parallel such that the transmission of pedigree data through at least a subset of the individuals occurs in each sampling cycle.

30. A pedigree data structure according to claim 29, where the entire pedigree data structure is represented on the FPGA device or the ASIC.

31. A pedigree data structure according to claim 30, where a copy of the entire pedigree data structure is also represented on the FPGA device or the ASIC.
